(19) United States
(12) Patent Application Publication
(10) Pub. No.: US 2008/0180335 A1
(43) Pub. Date: Jul. 31, 2008

(54) System and Method for Focusing Antenna Signal Transmission

(75) Inventor: John Sanford, Encinitas, CA (US)

Correspondence Address: HARNESS, DICKEY, & PIERCE, P.L.C, 7700 Bonhomme, Suite 400, ST. LOUIS, MO, 63105, US

(73) Assignee: CUSHCRAFT CORPORATION, Manchester, NH (US)

(21) Appl. No.: 11/627,044

(22) Filed: Jan. 25, 2007

(51) Int. Cl. H01Q 19/06

(52) U.S. Cl. 343/753

(57) ABSTRACT

The system contains an antenna feed. A signal is in communication with the antenna feed. The signal has a wavelength and a period. A signal lens has a periphery portion that is thicker than an interior portion, wherein the signal propagates through the signal lens. The signal lens is designed such that the signal propagates through the periphery portion of the signal lens approximately one wavelength slower than through the interior portion of the signal lens.

### FIELD OF THE INVENTION

The present invention is generally related to antennas, and more particularly is related to a system and method for focusing antenna signal transmission.

### BACKGROUND OF THE INVENTION

Occasionally, basic radiating structures are integrated into a radio housing. These structures, such as dipoles, patch and horn antennas are generally low gain devices. Structures such are reflectors or lenses can be used to augment the low gain and produce a more directive beam. However, lenses can be too expensive and too heavy for many antenna applications applications. Preferably, a device would be able to augment the low gain without the weight of a microwave lens. The reduced material usage results in a more cost effective product.

The design does not employ traditional lens theory or the techniques used in zoned lenses. It is most applicable to lenses with directivities in the range of 12-25 dB. The resulting structures have focusing performance similar to a lens shaped like a common magnifying glass but with much less total material usage.

Thus, a heretofore unaddressed need exists in the industry to address the aforementioned deficiencies and inadequacies.

### SUMMARY OF THE INVENTION

Embodiments of the present invention provide a system and method for focusing antenna signal transmission. Briefly described, in architecture, one embodiment of the system, among others, can be implemented as follows. The system contains an antenna feed. A signal is in communication with the antenna feed. The signal has a wavelength and a period. A signal lens has a periphery portion that is thicker than an interior portion, wherein the signal lens is impinged by the signal.

The present invention can also be viewed as providing methods for focusing antenna signal transmission. In this regard, one embodiment of such a method, among others, can be broadly summarized by the following steps: transmitting a signal from the antenna feed; transmitting the signal through an interior portion of a signal lens; and transmitting the signal through a periphery portion of the signal lens, wherein the signal is transmitted through the periphery portion slower than the interior portion.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a cross-sectional side view of an antenna system, in accordance with a first exemplary embodiment of the present invention.

FIG. 2 is a side view of the antenna system, in accordance with the first exemplary embodiment of the present invention.

FIG. 3 is a cross-sectional side view of an antenna system, in accordance with a second exemplary embodiment of the present invention.

FIG. 4 is a flowchart illustrating a method for focusing antenna signal transmissions.

### DETAILED DESCRIPTION

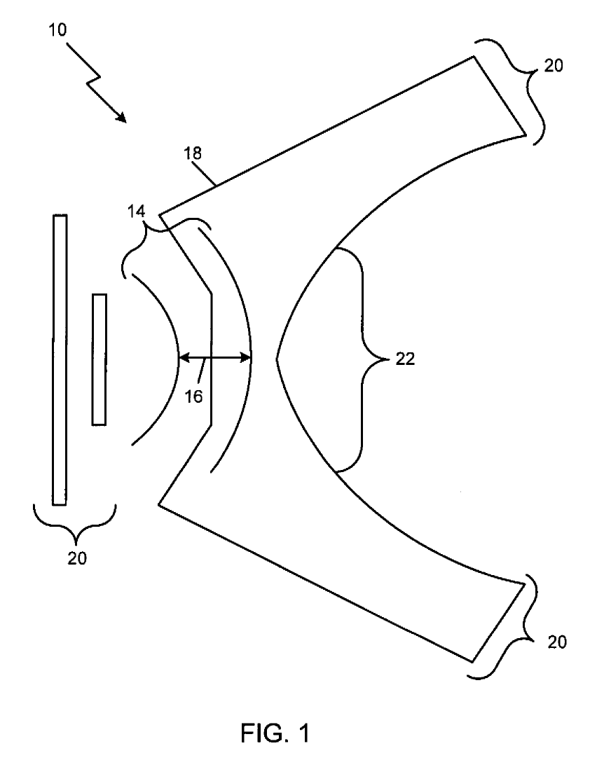

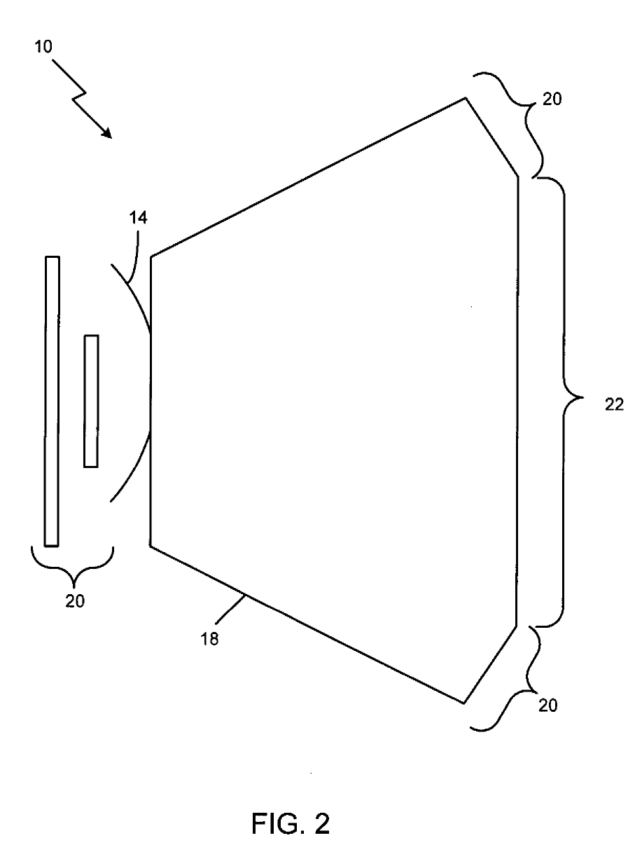

FIG. 1 is a cross-sectional side view of an antenna system 10, in accordance with a first exemplary embodiment of the present invention. FIG. 2 is a side view of the antenna system 10, in accordance with the first exemplary embodiment of the present invention. The antenna system 10 contains an antenna feed 12. A signal 14 is in communication with the antenna feed 12. The signal 14 has a wavelength 16 and a period. A signal lens 18 has a periphery portion 20 that is thicker than an interior portion 22, wherein the signal 18 at least partially propagates through the signal lens 14.

The signal lens 18 will be of a material that allows the signal to propagate therethrough. The signal 14 will propagate through the signal lens 18 slower than it propagates through air, or which ever medium in which the signal lens 18 is immersed. The arrangement of the signal lens 18 is designed to cause a portion of the signal 14 propagating through the periphery portion 20 of the signal lens to lag a portion of the signal 14 propagating through the interior portion 22. Specifically, as the periphery portion 20 is thicker than the interior portion 22, the portion of the signal 14 propagating through the periphery portion 20 will still be propagating through the signal lens 18 when the portion of the signal 14 propagating through the interior portion 22 has exited the signal lens 18.

The antenna feed 12 can be any feed known to those having ordinary skill in the art. For the purpose of further focusing transmissions and otherwise conserving energy, the antenna feed 12 may be designed to focus its signal 14 transmissions toward the signal lens 18, although the antenna feed need not provide any type of directionality for the invention to be operative.

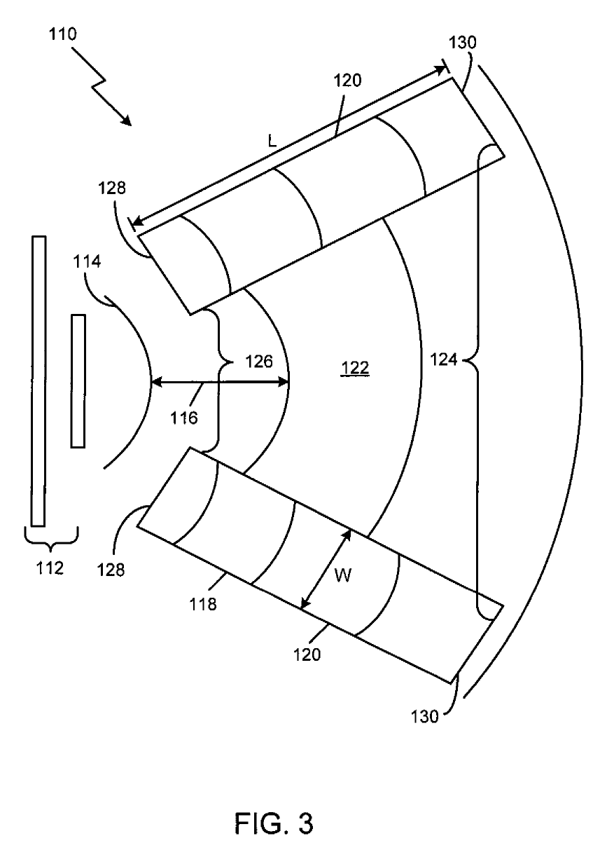

FIG. 3 is a cross-sectional side view of an antenna system 110, in accordance with a second exemplary embodiment of the present invention. The antenna system 110 contains an antenna feed 112. A signal 114 is in communication with the antenna feed 112. The signal 114 has a wavelength 116 and a period. A signal lens 118 has a periphery portion 120 and an aperture formed through an interior portion 122, wherein the signal lens 118 is impinged by the signal 114.

The signal lens 118 will be of a material that allows the signal to propagate therethrough. The signal 114 will propagate through the signal lens 118 slower than it propagates through air, or which ever medium in which the signal lens 118 is immersed. The arrangement of the signal lens 118 is designed to cause a portion of the signal 114 propagating through the periphery portion 120 of the signal lens to lag a portion of the signal 114 propagating through the aperture in the interior portion 122. Specifically, the portion of the signal 114 propagating through the periphery portion 120 will still be propagating through the signal lens 118 when the portion of the signal 114 propagating through the interior portion 122 has exited a distal opening 124 of the signal lens 118.

More specifically, the portion of the signal 114 propagating through the periphery portion 120 may be made to traverse the periphery portion 120 with approximately one wavelength than the portion of the signal 114 propagating through the interior portion 122 traverses the interior portion 122. Worded differently, a signal 114 reaching a proximate opening 126 of the signal lens and a proximate end 128 of the periphery portion may have the portion of the signal 114 propagating through the periphery portion 120 reach a distal end 130 of the periphery portion 120 approximately one wavelength behind the portion of the signal 114 propagating through the interior portion 122 reaches the distal opening 124. Similarly, after passing the signal lens 118, the portion of the signal 114 propagating through the periphery portion 120 may be a multiple of approximately one wavelength behind the portion of the signal 114 propagating through the interior portion 122.

As shown in FIG. 3, the distal opening 124 is larger than the proximate opening 126. A diameter of the distal opening 124 may be approximately three times a wavelength of the signal 114 or less, which has been shown in testing to provide positive results. A radial width W of the periphery portion 120 may be expressed approximately as λ/(2n) and the length L of the periphery portion 120 may be expressed approximately as λ/(n−1); where n is the dielectric constant of the lens material. For low loss materials it is approximately the square root the lenses' dielectric constant. These signal lens 118 dimensions, for a signal lens 118 made of a dielectric material, allow the portion of the signal 114 propagating through the periphery portion 120 to lag the portion of the signal 114 propagating through the interior portion 122 by a wavelength. The portion of the signal 114 propagating through the periphery portion 120 may then combine in phase with a subsequent cycle of a portion of the signal 114 propagating through the interior portion 122.

The signal lens 118, in the second exemplary embodiment, is shown to have a conical shape. Other shapes of the signal lens 118, such as a toroidal shape are conceivable for obtaining results similar to that of the present invention as described herein, and such signal lens 118 shapes are considered to be within the scope of the present invention.

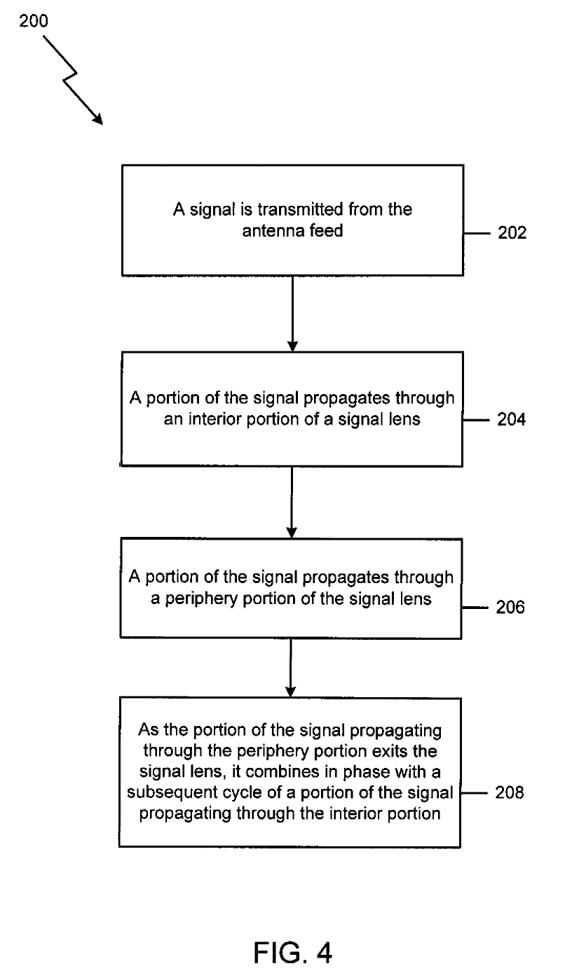

FIG. 4 is a flowchart 200 illustrating a method for focusing antenna signal transmissions, in accordance with the first exemplary embodiment of the invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 202, a signal 14 is transmitted from the antenna feed 12. A portion of the signal 14 propagates through an interior portion 22 of a signal lens 18 (block 204). A portion of the signal 14 propagates through a periphery portion 20 of the signal lens 18 (block 206), wherein respective portions of the signal 14 propagates through the periphery portion 20 slower than through the interior portion 22. As the portion of the signal 14 propagating through the periphery portion 20 exits the signal lens 18, it combines in phase with a subsequent cycle of a portion of the signal 14 propagating through the interior portion 22 (block 208).

While the invention has been described as focusing signals 14 being transmitted from the antenna feed 12, the invention is equally applicable for focusing signals 14 received at the antenna feed 12.

The design disclosed herein may provide reduced material usage, which provides a more cost effective product compared to a microwave lens. The design does not employ traditional lens theory or the techniques used in zoned lenses. It is most applicable to lenses with directivities in the range of 12-25 dB. The resulting structures have focusing performance similar to a lens shaped like a common magnifying glass but with much less total material usage.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

1. An antenna system comprising:
an antenna feed;
a signal in communication with the antenna feed, the signal having a wavelength; and
a signal lens, the signal lens having a periphery portion that is thicker than an interior portion, wherein the signal lens is impinged by the signal.

2. The antenna system of claim 1, wherein the signal lens further comprises a toroidal shape.

3. The antenna system of claim 1, further comprising an aperture formed in the interior portion.

4. The antenna of claim 3, wherein the thickness of the periphery portion relative to the interior portion is sized such that the signal propagates approximately one less wavelength through the midsection of the interior portion than the signal propagates through the periphery portion.

5. The antenna of claim 1, wherein the thickness of the periphery portion relative to the interior portion is sized such that the signal traverses approximately one less wavelength through the midsection of the interior portion than the signal propagates through the periphery portion.

6. The antenna of claim 1, further comprising a proximate opening and a distal opening formed in the interior portion, wherein the distal opening is larger than the proximate opening.

7. The antenna of claim 6, wherein the distal opening is approximately not more than three times the wavelength of the signal.

8. The antenna of claim 6, wherein a radial width of the periphery portion is approximately λ/(2n) and a length of the periphery portion is approximately λ/(n-1).

9. The antenna of claim 1, wherein the signal propagates a multiple of approximately one less wavelength through the midsection of the interior portion than the signal propagates through the periphery portion.

10. The antenna of claim 1, wherein the signal lens further comprises a segmented conical shape.

11. The antenna of claim 1, wherein the signal lens focuses the signal.

12. A method of communicating using an antenna feed, said method comprising the steps of:
transmitting a signal from the antenna feed;
propagating a portion of the signal through an interior portion of a signal lens; and
propagating a portion of the signal through a periphery portion of the signal lens, wherein the step of propagating through the periphery portion is slower than the step of propagating through the interior portion.

13. The method of claim 12, wherein the signal is transmitted through the periphery portion approximately one phase slower than the interior portion.

14. The method of claim 12, wherein the signal lens is approximately toroidial.

15. The method of claim 12, wherein the signal lens is approximately a conical segment.

16. The method of claim 12, wherein the antenna feed is a patch antenna.

17. The method of claim 12, further comprising combining in phase the portion of the signal propagating through the periphery portion of the signal lens with a subsequent cycle of the portion of the signal propagating through the interior portion of the signal lens.
